(19) United States
(12) Patent Application Publication
(10) Pub. No.: US 2026/0239219 A1
(43) Pub. Date: Aug. 13, 2026

(54) BATTERY-OPERATED DEVICES, INITIATOR DEVICE AND COMMUNICATION SYSTEM FORMED THEREWITH

(71) Applicant: PDi Digital GmbH, Fernitz-Mellach (AT)

(72) Inventor: Markus RUMPF, Fernitz-Mellach (AT)

(73) Assignee: PDi Digital GmbH, Fernitz-Mellach (AT)

(21) Appl. No.: 19/151,482

(22) PCT Filed: Jan. 3, 2024
(86) PCT No.: PCT/EP2024/050111

§ 371 Date: Jul. 28, 2025

(30) Foreign Application Priority Data
Jan. 31, 2023 (EP) 23154356.2

(51) Int. Cl. H04W 52/02; H04W 76/10

(52) U.S. Cl. CPC H04W 52/028; H04W 52/0216; H04W 52/0235; H04W 52/0277; H04W 76/10

(57) ABSTRACT

Battery-operated device, in particular a display device, comprising
a first communication stage for wireless communication, in particular radio communication, with a data processing facility, and
a second communication stage which is designed to wirelessly query with an initiator device, which differs from the data processing facility, whether there is a need for communication between the device and the data processing facility via the first communication stage, and
wherein the battery-operated device is designed to establish communication with the data processing facility with the aid of the first communication stage if the need exists.

### TECHNICAL FIELD

The invention relates to a battery-operated device, an initiator device and a communication system formed therewith.

### BACKGROUND

Nowadays, electronic battery-operated product and/or price displays, hereinafter referred to as electronic displays for short, which can be changed by radio in a communication system intended for operating the electronic displays, are used in modern salesrooms in order to display the most up-to-date product and/or price information possible to potential customers. Such electronic displays can, for example, be attached to shelves in a supermarket instead of paper labels or can also be attached to motor vehicles at a vehicle dealer, for example, as disclosed in WO 2020/193705. In order to keep the information conveyed with the aid of the electronic display up to date even over long distances, as is the case, for example, in the case of the vehicle dealer with its typically extensive outdoor presentation area, data is transmitted via a mobile radio network, for example using the NB-IoT standard, in accordance with WO 2020/193705. However, this has proven to be disadvantageous because this communication technology only allows very slow and energy-intensive data transmission. This means that the product and/or price information can either only be updated relatively rarely in order to save energy, or that the operation of the electronic displays requires a considerable amount of energy, which greatly impairs the service life of the batteries. This in turn causes considerable maintenance costs because the batteries have to be replaced or recharged more frequently. WO 2020/193705 discloses arrangements to reduce the amount of energy needed. However, it has been shown that in many cases these precautions are not sufficient to keep the product and/or price information presented by the electronic displays up to date in an energy-saving manner.

Against this background, the invention has set itself the task of providing a battery-operated device, in particular an electronic display device, as well as a communication system, wherein reliable and at the same time most energy-efficient communication of data possible should be enabled.

### SUMMARY OF THE INVENTION

This task is solved by a battery-operated device according to claim 1. The object of the invention is therefore a battery-operated device, in particular a display device, which comprises a first communication stage for wireless communication, in particular radio communication, with a data processing facility, and a second communication stage which is designed to wirelessly query with an initiator device, which differs from the data processing facility, whether there is a need for communication between the device and the data processing facility via the first communication stage, and wherein the battery-operated device is designed to establish communication with the data processing facility with the aid of the first communication stage if the need exists.

This task is further solved by an initiator device according to claim 12. The invention therefore relates to an initiator device which comprises a third communication stage for communicating, in particular for radio communication, with a data processing facility, wherein a necessity indicator, which indicates a need for communication between the data processing facility and another, in particular battery-operated, device is receivable, and a fourth communication stage, which is designed to wirelessly inform the other, in particular battery-operated, device, in particular the one querying with it, whether the need for communication between the other, in particular battery-operated, device and the data processing facility exists.

This task is further solved by a communication system according to claim 15. The invention therefore relates to a communication system comprising at least one battery-operated device according to the invention and at least one initiator device according to the invention.

The advantage of the measures according to the invention is that the data communication of each individual battery-operated device in the system with the data processing facility is limited to what is absolutely necessary. Continuous and direct queries with the data processing facility by all battery-operated devices existing in the system as to whether there is a need for communication with the data processing facility are thus avoided. This has a positive effect on the availability of the data processing facility in the system for communication with those devices for which there is an (urgent) need for communication, e.g. because more up-to-date data needs to be transmitted. Not only is the available bandwidth used sparingly in contactless communication, i.e. radio communication or communication based on light, such as infrared light, but the responsiveness of the data processing facility is also maintained in the event of a need for individual communication, because the data processing facility does not have to constantly respond to the large number of often useless or superfluous queries. In addition, the battery-operated devices also have the advantage that they save the energy otherwise required for the continuous direct, often unnecessary, queries with the data processing facility.

Advantageously, this enables energy-saving data communication, because communication via the first communication stage of the battery-operated device, which is relatively energy-intensive compared to communication via the second communication stage, is only established if there is an actual reason for such communication. An energy-intensive communication setup and the associated communications via the first communication unit without subsequent content-related data transmissions can thus be avoided.

According to the invention, the initiator device acts here as an initiator for communication between the respective battery-operated device and the data processing facility, but only if the prerequisite is met that communication is necessary at all. The initiator device is a device that is different from the data processing facility, but which is informed by the data processing facility that communication with one of the battery-operated devices is necessary. In the communication system in which a group of the battery-operated devices is localized in the contactless communication range of the initiator device, the initiator device can thus serve as an initiator for this group of battery-operated devices in order to selectively instruct those battery-operated device(s) within the group that there is a need for communication with the data processing facility.

For this purpose, a necessity indicator was transmitted by the data processing facility—at an upstream point in time in the past—to the initiator device, which makes it possible to uniquely identify the battery-operated device concerned or a number (group) of such battery-operated devices.

Further, particularly advantageous embodiments and further developments of the invention result from the dependent claims and the following description.

The data processing facility thus provides the data for the battery-operated device for display there as well as for the initiator device to indicate the need for communication with the respective battery-operated device. It can also retrieve data from this device. The data processing facility can be designed as a local computer or as a server, which supplies the respective device with data as a client or obtains data from the client. However, the data processing facility can also be a cloud-based software solution that is provided with the help of a computing center connected to the Internet. The data processing facility can communicate with the initiator device on the one hand and with the battery-operated device(s) on the other via a suitable communication stage.

It should be noted that battery-operated devices are to be understood as devices that comprise replaceable or rechargeable batteries or accumulators or that can be connected to a (replaceable or rechargeable) battery. Of course, other energy storage devices such as capacitors, in particular supercapacitors, can also be used here instead of a conventional battery. A battery-operated device can also be understood as a photovoltaically-operated device that comprises a solar cell or a solar panel to generate electricity for its operation. This electricity can be buffered or stored at least temporarily with the aid of an energy storage device, such as a capacitor, a supercapacitor or a rechargeable battery.

The need to establish communication with the data processing facility is given from the perspective of the data processing facility when it wants to transmit data to the battery-operated device or query data from the battery-operated device. This need, namely to establish communication with the data processing facility, can be indicated, for example, in such a way that necessity data representing the necessity indicator is stored at the initiator device. The necessity data was received from the data processing facility at a time in the past, as mentioned above.

In a preferred embodiment, the necessity indicator may be designed such that it allows unique identification or addressing of the battery-operated device concerned, or at least identifies or addresses a subgroup within the group of battery-operated devices. In this case, the querying battery-operated device, whose identity or unique address matches the identity indicated by the necessity indicator, is informed in an addressed manner that it should establish communication with the data processing facility.

Within the scope of a further embodiment, however, the necessity indicator can also be designed in such a way or interpreted in the communication system such that it causes the initiator device not to send a response to a query from the battery-operated device for which there is a need to establish communication with the data processing facility—e.g. within a predefined time window. This is interpreted by the battery-operated device as meaning that it subsequently, e.g. immediately, establishes communication with the data processing facility. If, on the other hand, the battery-operated device receives a response from the initiator device, the battery-operated device does not establish communication with the data processing facility. This system behavior is not to be confused with a failure to establish a connection between the battery-operated device and the initiator device, which will be discussed further on in the general description.

In both embodiments, the necessity data is received by the initiator device via the third communication stage and processed there according to the respective embodiment. The necessity data can be provided individually for each of the battery-operated devices present in the communication system or can also be provided in list form. In addition to indicating the need, the necessity data can also provide further information, such as a preferred time at which the communication of the battery-operated device with the data processing facility is to be established.

The first communication stage of the battery-operated device and the third communication stage of the initiator device as well as the data processing facility or the communication stage connected to the data processing facility are designed to communicate by means of a first wireless communication technology, whereby they form components of a first communication network, in particular a first radio network. This first communication technology is used here in particular for communication between the first communication stage and the data processing facility as well as between the third communication stage and the data processing facility.

The first communication technology allows data transmission over long distances. In the application case of the vehicle dealer discussed, for example, a communication network that allows data transmission over several kilometers can be established in order to update the battery-operated device in the vehicle even during test drives with a vehicle.

It has proven to be advantageous that the first communication network is a wide area network (WAN), in particular a low-power wide area network (LPWAN), which, in contrast to the “classic” WAN, is designed to transmit data at a low bit rate. Preferably, therefore, both the first communication stage of the battery-operated device and the third communication stage of the initiator device as well as the data processing facility or the communication stage connected to the data processing facility are designed for communicating via a wide area network, in particular for communicating via a low-power wide area network. Accordingly, the first communication stage, the third communication stage and the data processing facility or the communication stage assigned to it can be designed to communicate using LTE-M (also comprising the eMTC specifications LTE Cat M1, LTE Cat M2, etc.) or using the Narrowband Internet of Things standard, or NB-IoT standard for short. LTE stands for “Long-Term Evolution” and is a standard for wireless broadband communication for mobile devices and data terminals. LTE is based on the GSM/EDGE and UMTS/HSPA standards, which is generally known to the person skilled in the art. The skilled person is also aware that LTE-M (or LTE-MTC (M or eMTC stands for “enhanced Machine Type Communication”) is an LPWAN radio technology standard that was developed as part of the 3GPP (3 GPP stands for “3rd Generation Partnership Project”) in order to enable a wide range of mobile devices and services. In contrast to LTE-M, NB-IoT, whose standard was also developed as part of the 3GPP, has a lower data rate and is cheaper to implement. It is also possible that a Long Range Wide Area Network, LoRaWAN for short, is used as the first communication network. LoRaWAN is a low-power wireless network protocol defined by the LoRa Alliance. The implementation on the end device side or the implementation in gateways is carried out in LoRaWAN using a proprietary and patented transmission method based on a chirp spread spectrum modulation technology called “LoRa” from Semtech Corporation. The common cellular mobile radio standards or specifications 2G to 5G etc., which are well known to experts, can also be used in the first communication network.

The second communication stage of the battery-operated device and the fourth communication stage of the initiator device are designed to communicate with each other by means of a second wireless communication technology, forming components of a second communication network, in particular a second radio network. This second contactless communication technology is used here in particular for communication between the initiator device and the battery-operated devices associated with the initiator device.

The second wireless communication technology is optimized for high-speed data transmission (high bit rate) and/or energy-efficient data transmission. The achievable range is preferably shorter than that of the first wireless communication technology in order to enable local wireless communication. Due to the high transmission speed, data transmission only takes a relatively short time and is therefore energy-efficient. Data can be transmitted, for example, in the infrared or optical frequency range of light, e.g. according to the Infrared Data Association standard (IrDA for short) or using Li-Fi (Visible Light Communication interest group, IEEE 802.15.7). Li-Fi is a wireless communication technology in which light in the visible, ultraviolet or infrared spectral range is used for data transmission. Preferably, however, data is transmitted in the radio frequency range, using technologies known to the skilled person in connection with Bluetooth (administered by the Bluetooth Special Interest Group (SIG) and kept up to date by the Bluetooth SIG Working Groups), WLAN (IEEE standards 802.11, 802.11b etc.), ZigBee (IEEE 802.15.4, Connectivity Standards Alliance) or NFC (standardized in ECMA-340 and ISO/IEC 18092). For this purpose, communication protocols corresponding to the respective technology or a proprietary, extremely energy-efficient and reliable communication protocol, such as that known from WO2015124197, can be used

The second communication network is preferably a wireless local area network or a wireless personal area network, because the radio coverage area should typically be well localized or delimited in terms of range for typical applications, such as in connection with the aforementioned vehicle dealer.

Connection-oriented or connectionless data transmission can be used for data transmission using the second communication technology. “Connection-oriented communication” is a type of data transmission in which the devices at the end points establish an end-to-end connection using a protocol before data is sent. This means that a participant must register with the recipient before transmitting information. In contrast, with connectionless communication, each communication partner can be reached directly, i.e. without prior registration. In the present context, connection-oriented data transmission has the advantage that the initiator device clearly knows whether the battery-operated device is ready for data provision or whether data provision was successful. Connectionless data transmission has the advantage that the communication time (and thus the energy consumption) is kept to a minimum because no time-consuming connection establishment etc. is required.

The first communication network or the first communication technology is therefore designed for data transmission over a greater distance than the second communication network or the second communication technology. Accordingly, the first communication stage and the third communication stage are designed for more far-reaching communication, i.e. over a further distance, than the second communication stage and the fourth communication stage. The two communication technologies are therefore preferably designed differently in terms of their range.

The second communication network or the second communication technology is preferably designed for faster and/or more energy-saving data transmission than the first communication network or the first communication technology. Accordingly, the second communication stage and the fourth communication stage are designed for faster and/or more energy-saving communication than the first communication stage and the third communication stage.

The second communication technology is thus optimized for communication within the group with the initiator device, whereas the first communication technology is optimized for communication with the data processing facility. The second communication technology is thus designed for a short range in comparison to the first communication technology because, in an application-oriented system configuration, the distances between the initiator device and the battery-operated devices grouped in its transmission range are typically much shorter than the distance between said devices and the data processing facility or those radio system components (such as the aforementioned communication stage) that are used for radio communication with the data processing facility. For example, the two communication technologies can also be distinguished in such a way that the second communication network realized with them is designed more for local radio communication, whereas the first communication technology is designed for regional or supra-regional radio communication. In the second communication network, for example, at least one so-called access point with a range for radio communication of up to several hundred meters can be installed as one of the network components. In the first communication network, for example, a radio mast used in cellular mobile radio technology, which allows a range for radio communication of several kilometers, can be provided as one of the network components.

As discussed, wireless communication or wireless querying and wireless communication can be based on different technologies that are characterized by the fact that the signal transmission is at least partially cable-free. However, “wireless” does not mean that cables cannot also contribute to signal transmission. For example, cables can be used to connect the hardware components involved in the transmission, particularly within a device. An antenna can also use a cable. In particular, a cable or wired or similar connection for signal transmission is preferably provided respectively between the first communication stage and the second communication stage of the battery-operated device as well as between the third communication stage and the fourth communication stage of the initiator device.

According to one aspect of the invention, the second communication stage is designed to instruct the first communication stage for the purpose of establishing communication with the data processing facility if the need exists. This is preferably done by wire. For this purpose, the necessity data is first received and decoded so that the battery-operated device is aware of the existence of the need. In order to transmit the instruction from the second communication stage to the first communication stage, a control line can be provided, whereby the instruction is transmitted by means of a control signal. However, a bus system may also be provided to transmit the instruction from the second communication stage to the first communication stage, the instruction being transmitted by means of a bus command.

Likewise, the initiator device preferably comprises a wired connection between the third and fourth communication stage, which can be realized, for example, as a control line or bus system. The initiator device is preferably designed to transmit the necessity indicator or a representation of the necessity indicator to the fourth communication stage via the wired connection, so that it is possible, via the fourth communication stage, to inform the respective battery-operated device, in particular the one querying with it, whether or not the need exists.

Establishing communication via the first communication stage when the need exists can, for example, consist of starting or establishing a connection between the first communication stage and the data processing facility. However, activation can also consist, for example, of initiating a data exchange via an already established connection.

It has proven to be advantageous that the battery-operated device comprises an active mode and an energy-saving mode, wherein in the active mode, at least the first communication stage is ready for communication with the data processing facility, and wherein in the energy-saving mode, at least the first communication stage is deactivated, in particular with regard to its communication capability, in particular is switched off, and wherein the device is designed to transfer at least the first communication stage from the energy-saving mode to the active mode if the need exists. This allows the targeted activation of at least the first communication stage, which enables the energy requirement to be regulated or controlled. In particular, the energy requirement can thus be significantly reduced over longer periods in which there is no need for communication.

It has proven to be particularly advantageous here that the second communication stage of the battery-operated device is designed to initiate the transfer of at least the first communication stage from the energy-saving mode to the active mode if the need exists. In the energy-saving mode, individual components of the device are either completely switched off, i.e. powerless, or at least their processing capability is stopped. When the active mode is initiated, either the powerless component is supplied with power again or processing by the stopped component is continued or started newly. Both can be carried out using a signal, such as an interrupt signal at hardware level, so that the implementation is as reliable as possible. In this way, possible latencies that could occur due to software processing can be reliably avoided.

Furthermore, it has proven to be advantageous that the first communication stage is designed to enter into the energy-saving mode after communication with the data processing facility has ended. In this way, the energy consumption is automatically reduced after communication with the data processing facility and the battery life is extended. As a result of these measures, the first communication stage is reliably active only when it is also carrying out communication. Energy consumption due to a first communication stage that is ready to communicate but not communicating can thus be completely prevented. This can significantly reduce overall energy consumption.

For various reasons, a connection between the battery-operated device and the initiator device may not be possible. This can occur, for example, in the vehicle dealer's case of use when a vehicle and the battery-operated device inside it are on a test drive where there is no initiator device within the communication range of the second communication stage. Even in this situation, however, it is desirable for the device data to be kept up to date.

It has therefore proven to be advantageous that the battery-operated device is designed, in the event of a failed communication attempt, preferably in the event of several failed communication attempts, particularly preferably in the event of several immediately consecutive communication attempts, with the initiator device, to establish communication with the data processing facility with the aid of the first communication stage.

Thus, if communication via the second communication network is not possible, communication is started autonomously via the first communication stage in order to query directly from the data processing unit whether new data is available, which is equivalent to asking whether communication with it is necessary. This means that the data from the battery-operated device is always up to date. Because communication with the initiator device is possible in most cases (for example, because the vehicle is stationary most of the time in the salesroom or on the vehicle seller's premises), an enormous amount of energy can be saved even if the connection to the initiator device occasionally fails (for example, during test drives).

The device is therefore preferably designed to establish communication with the data processing facility via the first communication stage if the query is confirmed via the second communication stage that a need exists, or if the need exists because communication via the second communication stage is not possible or cannot be established.

The fact that communication with the data processing facility is only established autonomously after several failed communication attempts has the advantage that the chance of ultimately successful communication via the second communication stage is increased during the period of the communication attempts, which statistically reduces energy consumption over a longer period of time because energy-intensive communication via the first communication station, which is often unnecessary, can be dispensed with more frequently.

As discussed at the beginning, the above measures can be applied to transmit product and/or price information from the data processing facility to the device in order to be presented there. Therefore, the battery-operated device is preferably designed as a display device and comprises a display unit, in particular comprising a screen, for displaying product and/or price information.

The device can have an energy-saving display unit, such as an LCD display. Preferably, however, the technology used is based on electronic ink or electronic paper technology. Such a display unit therefore has a reflective screen, also known in technical jargon as an electronic paper display, abbreviated EPD, and is realized with the aid of “electronic paper”, or “e-paper” or “e-ink” for short.

If the battery-operated device has a display, the data provided by the data processing facility often represents display information, in particular product and/or price information. In this case, the battery-operated device is designed to receive the display data via the first communication stage and to display the display information transported with it.

However, the battery-operated device can also be designed to generate data. For this purpose, a generation unit can be provided instead of the display unit or preferably in addition to the display unit. Such a generation unit can, for example, be an input device such as a touch screen, a keyboard, buttons or the like or a sensor such as a camera, a microphone, a location sensor, etc.

In order to provide the generated data in an energy-saving manner and at the same time as up-to-date as possible, it has proven to be advantageous that the device is designed to output data that was generated before communication with the data processing facility was established, in particular in the device, to the data processing facility via the first communication stage. This allows the device to collect data over long periods of time and then output it in bundles. It is particularly advantageous if the device is designed to utilize the first communication stage in its active mode to output data generated during its energy-saving mode. This means that no intermediate activation is necessary for the output of the generated or collected data. Rather, the fact that communication with the data processing facility is necessary is immediately utilized by the battery-operated device to output its collected data to the data processing facility.

The energy-saving mode is to be understood here in particular as the energy-saving mode of the first communication stage and, if applicable, other components. Those components that are involved in generating the data are, of course, active as necessary while the energy-saving mode is active. Furthermore, a storage stage can be provided to temporarily store the generated data. For example, data is generated by the sensor (which is provided as an exemplary generation unit) while the first communication stage is in energy-saving mode, and this generated sensor data is temporarily stored in the memory stage, from where it is read out in the next active mode of the first communication stage and sent by the first communication stage or transmitted to the data processing unit.

As discussed, the second communication network is preferably more energy-efficient than the first communication network. Therefore, frequent communication via the second communication network is more energy-efficient than correspondingly frequent communication via the first communication network. However, in order to further reduce energy consumption, it has proven to be advantageous to also communicate via the second communication network depending on demand.

It has therefore proven to be advantageous that the second communication stage is designed to make the query with the initiator device depending on a trigger signal.

According to one aspect of the invention, the battery-operated device comprises a sensor (touch sensor, temperature sensor, sensor for sound detection, sensor for image detection, sensor for position detection), in particular a motion sensor, which is provided for generating the trigger signal. This allows data to be updated precisely when there is a need for an update, for example because a vehicle is unparked for a test drive and thus moved. The update process can also be triggered by simply shaking the battery-operated device manually.

According to a further aspect of the invention, the battery-operated device is designed to generate the trigger signal depending on the time. This measure ensures that any updates that may be present are always kept up-to-date in a timer-controlled manner. This measure also makes it possible to establish synchronism in the communication system. For example, the individual battery-operated devices can be assigned time slots in which they must report to the initiator device. If this communication fails to take place, possibly several times, the initiator device can send a corresponding message to the data processing facility in order to trigger further measures.

Of course, both aspects can also be used to generate the trigger signal (sensor-and time-controlled). For example, in addition to the trigger signal generated depending on the time, which keeps the device up to date within the desired time intervals, a sensor-dependent trigger signal can trigger a premature (unscheduled) update. For example, such a situation can occur at a car dealer when a test drive has just been started.

Furthermore, it has proven to be advantageous if the second communication stage is also designed to adopt an active mode and an energy-saving mode. In this case, the adoption of a respective mode can also be triggered by the trigger signal (or various trigger signals). Preferably, the second communication stage changes from the energy-saving mode to the active mode or from an active mode to the energy-saving mode as a function of time, in particular periodically. If a more energy-saving communication technology is used for the second communication stage, the system can be operated in an energy-saving manner even if the active mode is used frequently.

The aforementioned measures thus allow energy-efficient operation of the battery-operated device by means of energy management based on the information communicated by the initiator device regarding the need to communicate with the data processing facility.

As far as the realization of the initiator device is concerned, it should be noted that this can be based on different embodiments.

According to a first embodiment, the initiator device is formed by a device according to the invention, wherein the third communication stage is formed by the first communication stage and wherein the fourth communication stage is formed by the second communication stage. Thus, the number of different devices required in the system can be kept to a minimum, because ultimately only a single common embodiment is required for the initiator device and the battery-operated device.

One of the at least two battery-operated devices of the communication system therefore assumes the role of the initiator device. This role can be predefined as stationary or can switch between the devices automatically, e.g. time-controlled or event-related, or can also be set manually. The respective role assumed by the respective battery-operated device can be set with the help of software running on the computer of the respective device, which provides the role-specific behavior of the device depending on the set role and also performs the necessary coordination between the devices for the role change.

The advantage of alternating roles is that energy consumption is distributed as evenly as possible across all devices in the communication system. As a result, maintenance work, such as changing batteries or the time for recharging rechargeable batteries or accumulators and the like, can be planned more reliably and carried out efficiently over a large area. The combination of assigned roles, which changes over time, and demand-based communication, which according to the invention only takes place with the data processing facility when it is necessary, means that the communication system can be operated in a more energy-efficient manner than would be the case if the aforementioned measures were not provided.

The roles can, for example, be assigned in such a way that this is controlled by the data processing facility. There, all devices that form a group, i.e. are in an area in which they can communicate with each other via the second communication stage or fourth communication stage, can be listed in a computerized list, for example in a memory of the data processing unit. The list is run through by the data processing facility in order to assign the role of initiator device to the battery-operated device listed in the respective list element. For example, after a certain time and/or after a certain number of established communications, the role of initiator device is passed on to the next battery-operated device in the list. This fact can be communicated to the devices in the communication system so that they all know which of them is the initiator device.

However, the role can also be passed on in such a way that, in the communication with the data processing facility, a battery status (battery charge level, e.g. specified as a percentage of the maximum possible charge of the battery) of the device currently communicating (i.e. the battery-operated device as well as the device currently assuming the role of initiator device) is transmitted respectively to the data processing facility. A comparison of the individual charge levels of the batteries available in the communication system at the data processing facility can be used to change the role assignment in the communication system. If, for example, the charge level of the battery of the device that currently has the role of initiator device falls below a threshold value (e.g. fixed or definable as depending on the other charge levels of the battery-operated devices), the initiator device can be instructed to hand over the role of initiator device to one of the other battery-operated devices that has a higher charge level. Preferably, the battery-operated device whose battery has the highest charge level is selected for this purpose. The energy stored in the batteries of the devices available in the communication system can thus be optimally utilized without one or more of the devices having an individually increased energy requirement due to excessively frequent use and thus being at a disadvantage.

A stationary role, on the other hand, has the advantage that only one device has a higher energy consumption compared to the other devices, while all other devices can be operated in an energy-saving manner. In this configuration of the communication system, only the battery of one battery-operated device predefined as an initiator device would have to be recharged at regular intervals or this battery would have to be replaced, while all other battery-operated devices can be operated with a battery life extended by the measures according to the invention. There is therefore no need for frequent checking and maintenance of the remaining battery-operated devices, whose maintenance intervals are extended accordingly. It should be noted that this advantage is also present if the initiator device is not designed as a battery-operated device.

In order to set the respective role for the battery-operated device, each of the battery-operated devices of the communication system is advantageously designed to receive role assignment data, which causes either the behavior of the initiator device or the behavior of the battery-operated device, and to process it in such a way that the role predetermined thereby is assumed. In a minimal configuration, the role assignment data may be defined by a single bit. However, the role assignment data can also contain further information, such as the time at which it becomes valid, e.g. to ensure synchronism in the communication system and to ensure with a high probability that all battery-operated devices present have received the information for the role change. In the case of the respective battery-operated device, the role assignment data can be received, for example, from the data processing facility via the first communication stage or from another device (e.g. the initiator device) via the second communication stage.

However, the roles can also be assigned in such a way that this is controlled by the battery-operated device currently assuming the role of initiator device. In this case, the initiator device generates and sends the role assignment data. For example, the battery-operated device currently assuming the role of initiator device can transmit the role assignment data to one of the other battery-operated devices after a certain time has elapsed and/or after the charge level of its battery has fallen below a threshold value and thus perform a role swap with this battery-operated device. The decision as to which of the available battery-operated devices is selected to assume the role of initiator device can be made for the battery-operated device currently assuming this role by comparing the different charge levels of the battery-operated devices querying it with regard to the need for communication with the data processing facility. Here too, the battery-operated device whose battery has the highest charge level can be selected in order to achieve the most uniform energy consumption possible for the battery-operated devices over the operating time for the communication system.

According to a preferred embodiment, however, the initiator device comprises a power supply or is connected to a power supply, whereby the power supply is more powerful than the power supply of the other, in particular battery-operated, device.

This measure allows the device that requires the most energy (i.e. the initiator device) to be supplied with energy reliably and over the long term, so that the entire communication system can be operated maintenance-free over a long period of time, because the data transmission is divided up in such a way that the time-consuming and energy-intensive communications with the data processing facility are largely carried out by the initiator device. This involves, for example, the initiator device maintaining contact with the data processing facility and thus ensuring that there is always an up-to-date status regarding the need for the data processing facility to communicate with one of the other devices. For this purpose, a large part of the energy used by the communication system is provided by the powerful energy supply.

The energy requirement that is covered by, for example, a weaker power supply device of the other devices or the battery of the battery-operated devices can thus be kept to a minimum, because a high energy requirement is only present there if communication with the data processing facility is actually necessary and is actually carried out.

As with the battery-operated device, the energy supply of the initiator device can be provided by means of a replaceable or rechargeable energy storage device, such as a battery or accumulator (or similar). In this case, the energy storage device has a higher energy storage capacity than the energy storage device (i.e. the battery) of the other battery-operated device. This means that all devices, in particular the initiator device, of the communication system can be used in a mobile manner, i.e. independent of location. However, the communication system can also include several initiator devices powered in this way. Which of the initiator devices is currently in contact with the data processing facility in order to keep the other devices “up-to-date” about the need for communication can be negotiated between the initiator devices-e.g. depending on the respective state of charge of the battery of the initiator devices-for which, for example, the fourth communication level is used.

Preferably, the initiator device is designed to be connected to a power supply, in particular to a low-voltage power supply, preferably by means of a plug, particularly preferably by means of a power plug, or by means of a power supply unit. Thus, the power supply of the initiator device, i.e. the device which is intended to carry out most (most frequent) communications with the data processing facility (e.g. for keeping the information concerning the need for communication with the battery-operated devices up to date), is ensured essentially without interruption.

In the case of the wired (external) power supply of the initiator device, it can also be provided that the initiator device does not have to wait for a query from another battery-operated device, but sends this out by radio when the data processing facility needs to communicate with one of the battery-operated devices until the battery-operated device in question has completed the communication.

It should also be mentioned that the initiator device (even when using the more powerful power supply) can in principle also be designed to perform the same tasks as the battery-operated device. For example, the initiator device can also be designed to display product and/or price information and/or to generate data by means of a generation unit. In contrast to this all-encompassing design, however, the initiator device can also be designed such that it merely “manages” the communication between the data processing unit and the battery-operated device, i.e. informs the battery-operated device when there is a need for communication with the data processing facility, without providing any further functionalities.

Finally, it should be mentioned in general terms that the electronic devices discussed (such as those mentioned, i.e. the data processing facility, the battery-operated device and the initiator device, etc.) naturally comprise electronics. The electronics may be discrete or integrated electronics or a combination of both. Microcomputers, microcontrollers, application specific integrated circuits (ASICs), possibly in combination with analog or digital electronic peripheral components, can also be used. Many of the mentioned functionalities of the devices are realized—possibly in interaction with hardware components—with the help of software that is executed on a processor of the electronics. Devices designed for radio communication usually have an antenna configuration for transmitting and receiving radio signals as part of a transceiver module.

These and other aspects of the invention are shown in the figures discussed below.

### SHORT DESCRIPTION OF FIGURES

The invention is explained in more detail below with reference to the attached figures using examples of embodiments, to which the invention is not, however, limited. In the various figures, identical components are provided with identical reference signs. The figures show schematically:

FIG. 1 A communication system according to the invention in the form of a block diagram, with a mains-powered initiator device and a battery-operated device;

FIG. 2 An application example of the communication system shown in FIG. 1;

FIG. 3 Status diagrams of four devices of the application example shown in FIG. 2.

### DESCRIPTION OF THE DESIGN EXAMPLES

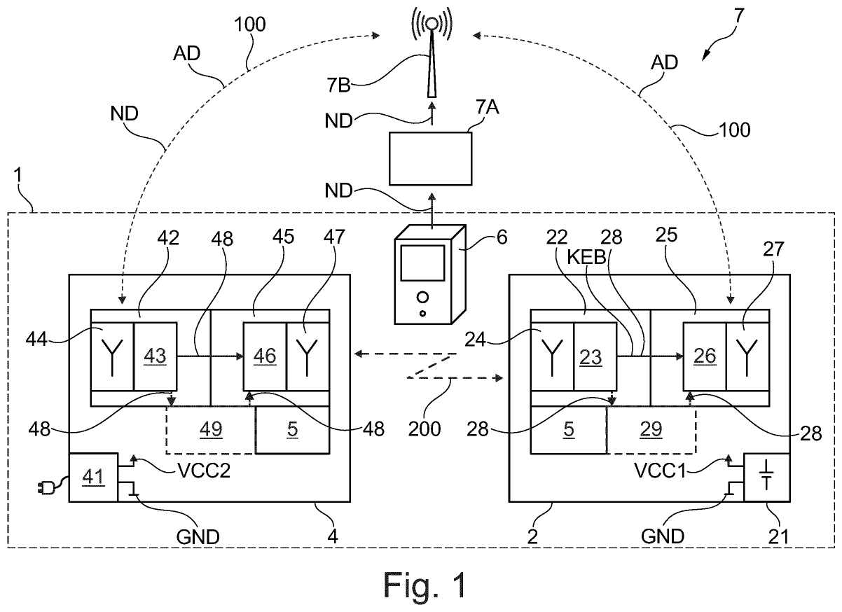

FIG. 1 shows a communication system 1 comprising a battery-operated device 2, an initiator device 4 and a data processing facility 6. Outside the communication system 1 there is a low-power wide-area network 7, LP-WAN 7 for short, for transmitting data between, on the one hand, the data processing facility 6 and the initiator device 4 and, on the other hand, the data processing facility 6 and the battery-operated device 2.

A communication stage 7A and a radio system, of which a radio mast 7B is shown symbolically, are assigned to the LP-WAN 7. The LP-WAN 7 is designed for communication in accordance with the Narrowband Internet of Things standard, or NB-IoT standard for short. The communication stage 7A is a cloud infrastructure that can be implemented by a computing center, wired and/or radio-based communication components or devices. The communication stage 7A allows the data processing facility 6, to which it is connected, to communicate via the LP-WAN 7. The radio mast 7B represents the physical interface for receiving and transmitting radio signals, i.e. radio communication with a wide variety of devices in the LP-WAN 7. In such an LP-WAN 7, a relatively large number of such communication facilities 7A and radio masts 7B can in principle excite in order to obtain supra-regional, possibly even nationwide radio coverage. The simplified representation chosen here serves only to provide a compact explanation of the principle of the invention.

The battery-operated device 2 comprises a battery 21, which is provided for its energy or power supply and provides a first supply voltage VCC1 with respect to a reference potential GND. This battery supply requires the NB-IoT functionality to be used as sparingly as possible because it is very energy-intensive. For this reason, NB-IoT (radio) communication 100 with the data processing facility 6 only takes place when it is actually necessary, which will be discussed in detail below.

The battery-operated device 2 further comprises a first communication stage 25 for the aforementioned purpose of receiving the product and/or price information. For reasons of clarity, the first communication stage 25 is structured into a first microcontroller or computer 26 and a first transceiver 27, of which only an antenna configuration is symbolically shown. The first computer 26 is primarily used to implement the NB-IoT communication protocol or standard and therefore enables standard-compliant wireless communication.

The battery-operated device 2 further comprises a second communication stage 22. For reasons of clarity, the second communication stage 22 is structured into a second microcontroller or computer 23 and a second transceiver 24, of which only one antenna configuration is shown symbolically. The second computer 23 is primarily used to implement a Bluetooth communication protocol for the purpose of Bluetooth communication 200 with the initiator device 4 and accordingly enables standard-compliant radio communication.

The battery-operated device 2 is further designed to send a query to the initiator device 4 via Bluetooth communication 200, thereby querying whether the battery-operated device 2 should establish NB-IoT communication 100 with the data processing facility 6. If a need for such NB-IoT communication 100 with the data processing facility 6 is transmitted from the initiator device 4 as a query response to the battery-operated device 2 via the Bluetooth communication 200, a connection of the first communication stage 25 with the data processing facility 6 is established via the LP-WAN 7.

This functionality is preferably realized in such a way that the second computer 23 transmits a communication establishment command KEB via a first data bus 28 to the first computer 26 of the first communication stage 25, where this command is executed. However, this functionality can also be realized in such a way that the battery-operated device 2 comprises a first central computer 29, via which the query response received from the initiator device 4 is evaluated and via which the communication establishment command KEB is ultimately issued to the first computer 26 of the first communication stage 25 or the NB-IoT communication 100 is transacted directly with the aid of the first transceiver 27.

The initiator device 4 comprises a power supply unit 41, which has a power plug for connection to a power supply system. The power supply unit 41 is used to supply energy or power to the initiator device 4 and provides a second supply voltage VCC2 with respect to a reference potential GND. The mains power supply provides NB-IoT communication capability without the need to take energy-saving behavior into account. This allows the initiator device 4 to be in NB-IoT radio contact with the data processing facility 6 virtually continuously or frequently, such as at relatively short periodic intervals, in order to receive, for example, necessity data ND. The necessity data ND indicates that NB-IoT communication 100 between the data processing facility 6 and the battery-operated device 2 is necessary or such a need exists.

The initiator device 4 comprises a third communication stage 42 for receiving the necessity data ND. The necessity data ND is transmitted via the LP-WAN 7 from the data processing facility 6. For reasons of clarity, the third communication stage 42 is structured into a third microcontroller or computer 43 and a third transceiver 44, of which only one antenna configuration is shown symbolically. The third computer 43 is primarily used to implement the NB-IoT communication protocol or standard and therefore enables standard-compliant wireless communication.

The initiator device 4 further comprises a fourth communication stage 45. For reasons of clarity, the fourth communication stage 45 is structured into a fourth microcontroller or computer 46 and a fourth transceiver 47, of which only one antenna configuration is shown symbolically. The fourth computer 46 is primarily used to implement the Bluetooth communication protocol for the purpose of Bluetooth communication 200 with the battery-operated device 2, and accordingly enables standard-compliant radio communication.

The initiator device 4 is further configured to receive and store the necessity data ND during an NB-IoT communication 100 with the data processing facility 6. The initiator device 4 is further designed to access the stored necessity data ND when receiving a query regarding a communication need via NB-IoT communication 100 between the battery-operated device 2 and the data processing facility 6 and to check whether such a need exists for the requesting battery-operated device 2. The result of this check is communicated to the querying battery-operated device 2 via Bluetooth communication 200 and processed there as discussed.

This functionality of the initiator device 4 is preferably realized in such a way that the third computer 43 transmits the necessity data ND received from the data processing facility 6 via a second data bus 48 to the fourth computer 46 of the fourth communication stage 45, where this necessity data ND is stored for processing of the query by the battery-operated device 2.

However, this functionality can also be realized in such a way that the initiator device 4 has a second central computer 49, via which the provision of the necessity data ND as well as a query by the battery-operated device 2 is processed.

The battery-operated device 2 realizes an electronic display panel with an electronic-ink-based, extremely energy-saving screen 5. The screen 5 is used to display product and/or price information provided by the data processing facility 6 by means of display data AD via the LP-WAN 7, i.e. communicated to the battery-operated device 2 via NB-IoT radio communication, wherein such NB-IoT communication 100 is to take place only when an update of the screen contents is to take place, or in other words, when a need for such NB-IoT communication 100 exists. The screen 5 may also be equipped with a screen microcontroller (not shown) that can communicate with the first computer 26 via the first bus 28 to receive the corresponding update data (display data AD) received via NB-IoT communication 100. The same applies mutatis mutandis in an adapted form to the initiator device 4, in which case there is no NB-IoT communication limitation due to energy-saving considerations.

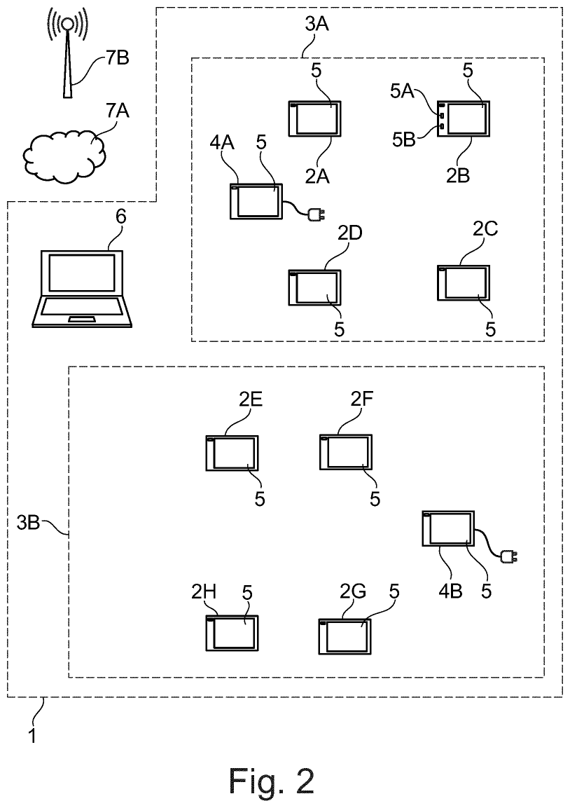

In the following, the application of the communication system 1 at a motor vehicle dealer is discussed with the aid of FIG. 2, in which two different exhibition areas 3A and 3B exist, whereby these are an open area 3A and a sales hall 3B. It should be noted here that the surface area of the two areas 3A and 3B does not correspond to the visualized proportions, as FIG. 2 is merely a schematic representation. Connecting lines (lines/cables) between network elements or indicated radio signals, as shown in FIG. 1, have been omitted here for the sake of clarity, although the facts discussed in connection with FIG. 1 are of course also present in the system visualized in FIG. 2.

A first group of the battery-operated devices 2A to 2D is located in the open area 3A of the motor vehicle dealer, each of the devices 2A to 2D being mounted on or in a vehicle (not shown). A first initiator device 4A also exists in the open area 3A, which is provided and set up for for Bluetooth communication 200 with the battery-operated devices 2A to 2D.

A second group of the battery-operated devices 2E to 2G is located in a sales hall 3B of the motor vehicle dealer, each of the devices 2E to 2G also being mounted there on or in a vehicle (not shown). A second initiator device 4B exists in the sales hall 3B, which is provided and arranged for Bluetooth communication 200 with the battery-operated devices 2E to 2G.

The battery-operated devices 2A to 2G are basically all realized according to the battery-operated device 2 shown in FIG. 1. An exception here is the battery-operated device 2B which, in addition to the screen 5 shown in FIG. 1, comprises a humidity sensor 5A and a temperature sensor 5B, these sensors 5A and 5B being either connected to the first bus 28 or connected to one of the microcontrollers 23, 26 or 29.

The two initiator devices 4A and 4B also each comprise a screen 5, analogous to the battery-operated devices 2A to 2G. In this embodiment example, however, they are not mounted on a vehicle, but are installed stationary in order to provide product and/or price information locally. However, they can also be provided in a vehicle. The initiator devices 4A and 4B are realized according to the initiator device 4 shown in FIG. 1.

In order to provide the product and/or price information presented on the screens 5 of the battery-operated devices 2A to 2G and the initiator devices 4A and 4B, the vehicle dealer may enter or select the desired information into the data processing facility 6. The data processing facility 6 may comprise a corresponding software application for this purpose, which enables this user interaction and the transmission of the resulting display data AD.

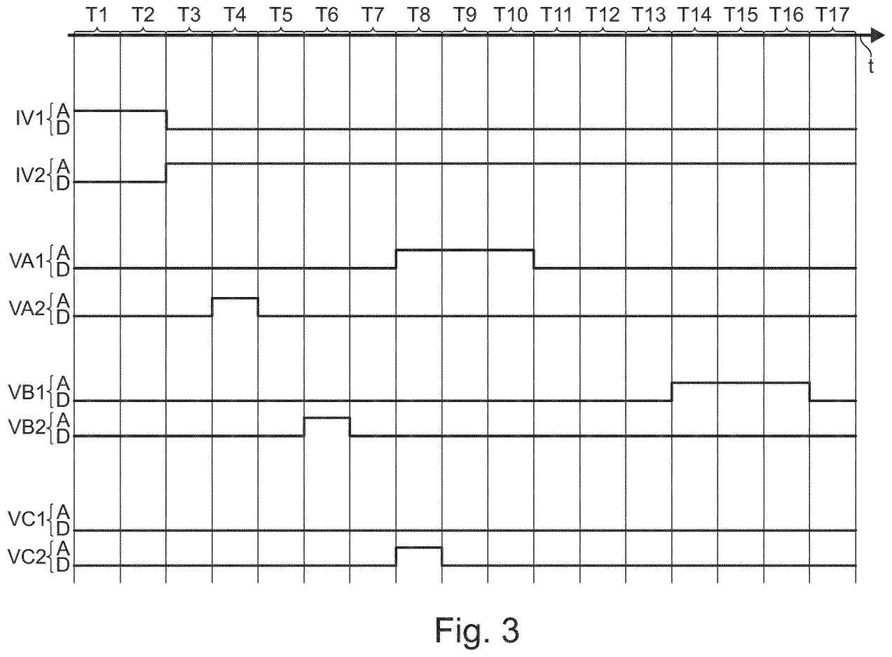

The data processing facility 6 then notifies the initiator devices 4A and 4B that there is a need for communication with the data processing facility 6 for the one or the other of the battery-operated devices 2A to 2G. Thereupon, the battery-operated devices 2A to 2G concerned, as soon as they query with the initiator device 4A or 4B, are instructed by the initiator devices 4A and 4B to establish communication with the data processing facility 6, as discussed below in the context of FIG. 3.

FIG. 3 shows the communication sequences in the communication system 1 in a temporal context in the form of status diagrams, with the statuses indicating either an activated status A or a deactivated status D. This is shown as an example for the first initiator device 4A and the first three devices 2A to 2C of the open area 3A.

FIG. 3 shows the sequence of statuses of the first initiator device 4A and the battery-operated devices 2A to 2C along the time axis t divided into 17 time ranges T1 to T17, each time range T1 to T17 corresponding to approximately one second in this example. However, depending on the programming of the software running on the devices 1A-1G or 4A and 4B, the time ranges T1 to T17 may take different lengths of time, and may even be individually long.

The status sequence of the third communication stage 42 of the initiator device 4A is represented by a first graph IV1. The status sequence of the fourth communication stage 45 of the first initiator device 4A is represented by a second graph IV2. Furthermore, the status sequence of the first communication stage 25 of the devices 2A is represented by a third graph VA1, the status sequence of the first communication stage 25 of the devices 2B is represented by a fourth graph VB1 and the status sequence of the first communication stage 25 of the devices 2C is represented by a fifth graph VC1, and the status sequence of the second communication stage 22 of the devices 2A is represented by a sixth graph VA2, the status sequence of the second communication stage 22 of the devices 2B is represented by a seventh graph VB2 and the status sequence of the second communication stage 22 of the devices 2C is represented by an eighth graph VC2. The graphs IV1, IV2, VA1, VA2, VB1, VB2, VC1, VC2 thus each represent whether the respective communication stage is activated, i.e. in its activated status A, or deactivated, i.e. in its deactivated status D, in a time range T1 to T17. In the activated status A, communication takes place with power consumption, whereas in the deactivated status D, there is significantly lower power consumption compared to the activated status A or no power consumption at all for the corresponding communication stage if it is completely switched off.

In the time ranges T1 and T2, the third communication stage 42 of the initiator device 4A is activated, whereby a list of the battery-operated devices 2A to 2D to be activated is queried by the data processing facility 6 via the LP-WAN 7 and then stored by the initiator device 4A. After receiving the list, the third communication stage 42 is deactivated and the fourth communication stage 45 is activated.

In the time range T4, the second communication stage 22 of the first battery-operated device 2A is activated by internal timer electronics (realized, for example, by means of one of the microcontrollers) of the battery-operated device 2A in order to query from the initiator device 4A by means of Bluetooth communication 200 whether data for the first battery-operated device 2A is available at the data processing facility 6. The stored list indicates that data is available for the first battery-operated device 2A, i.e. that there is a need for communication with the data processing facility 5, and also indicates a recommended time range T8 to T10 in which the first battery-operated device 2A should communicate with the data processing facility 6. At the beginning of the recommended time range T8, the first battery-operated device 2A then activates the first communication stage 25 to start communication with the data processing facility 6 via the LP-WAN 7 and retrieve the data. In this example, the data is display data AD representing new product and price information. After receiving the data, the first battery-operated device 2A updates the display unit 5 according to the new product and price information.

Similarly, in the time range T6, the second battery-operated device 2B queries from the initiator device 4A by means of the second communication stage 22 via Bluetooth communication 200 whether data is available at the data processing facility 6, that is, whether there is a need for communication therewith. Since the stored list indicates this need, communication with the data processing facility 6 is carried out via the LP-WAN 7 using the first communication stage 25 of the second battery-operated device 2B in the time ranges T14 to T16, which are also predefined in the list for the second battery-operated device 2B. In this NB-IoT communication 100, not only the data is retrieved from the data processing facility 6, but also the sensor data determined by the humidity sensor 5A and the temperature sensor 5B is transmitted to the data processing facility 6.

At time T8, the third battery-operated device 2C queries with the initiator device via Bluetooth communication 200 whether data is available for it, i.e. whether there is a need to communicate with the data processing facility 6. After there is no need for communication with the data processing facility 6 for the third battery-operated device 2C according to the stored list, i.e. there is no (display) data to be retrieved there, the first communication stage 25 of the third battery-operated device 2C remains deactivated and the second communication stage 22 is also deactivated until the next timer-controlled query with the initiator device 4A.

Similarly, the battery-operated device 2D (whose communication stages activity is not shown) also queries with the initiator device 4A in order to start and carry out the NB-IoT communication 100 with the data processing facility 6 as needed, retrieving (display) data and/or transmitting data to the data processing facility 6 as appropriate, which is not shown however.

For its part, the initiator device 4A updates the list of communication needs over time in a periodic or event-driven manner through NB-IoT communications 100 with the data processing facility 6.

The group of devices 2E-2G and 4B behave in a similar way.

In conclusion, with regard to the application example discussed, it can be stated that the measures mentioned allow communication via the low-power WAN 7 to be reduced to a minimum, which significantly reduces the energy requirement of the devices 2A to 2H, because communication via the LP-WAN 7 with the data processing facility 6 is only established when the respective need for communication, i.e. here in particular the need for communication due to the availability of the data, exists. At the same time, the available bandwidth or data transmission rate can be ideally utilized because the time distribution of the communication can be optimally designed using the measures mentioned.

With reference to the application example according to FIG. 2, it should also be mentioned that the radio communication coverage areas of the two initiator devices 4A and 4B or also of the groups of battery-operated devices 2A-2D and 2E-2G assigned to the two initiator devices can overlap at least in some areas (possibly only temporarily). In this case, when using the same frequency band, it is expedient to use different radio channels for each group 2A-2D and 2E-2G, which are far enough apart to ensure undisturbed communication with the respective initiator device 4A or 4B. However, it has proven to be particularly advantageous that different communication technologies are used for the communication between the initiator device 4A and the group of battery-operated devices 2A-2D on the one hand and the communication between the initiator device 4B and the group of battery-operated devices 2E-2G on the other hand. The choice of communication technology to be used in each case may depend on the particular application. For example, in the case of the car dealer, WLAN radio communication between the group of battery-operated devices 2A-2D and the initiator device 4A can be used for the spacious open area 3A in order to maximize the spatially available radio coverage area, and e.g. for the rather cramped sales hall 3B, a low-power Bluetooth radio traffic between the group of battery-operated devices 2E-2H and the initiator device 4B can be used in order to use the most energy-efficient communication technology possible for a relatively small required radio coverage area.

In another case of use, in which, for example, it can be assumed that the initiator device is moved past all battery-operated devices over time, either automatically, such as by moving a robot, or manually, with a distance of only a few millimeters to a few centimeters, NFC technology can even be used for communication between the initiator device and the battery-operated devices. In this case, the energy requirement on the part of the battery-operated device for querying the initiator device as to whether communication with the data processing facility is necessary can be virtually completely avoided. This is possible because the fourth communication stage 45 can be designed as an NFC read/write device (also referred to as an “NFC reader” in technical jargon). In this case, when inductive coupling is established with the second communication stage 22 realized as an NFC tag or NFC device, the fourth communication stage 45 also takes over the power supply of the second communication stage 22 via the inductive coupling. As long as the need for communication with the data processing facility 6 is not communicated in such a communication, the electronics of the battery-operated device can remain in a practically power consumption-free deep-sleep mode. Only when the need is communicated by means of NFC communication is the deep-sleep mode exited under the control of the second communication stage 22 and communication with the data processing facility 6 is carried out with power being provided from the battery 21.

Finally, it is pointed out once again that the figures described in detail above are only examples of embodiments, which can be modified by the skilled person in various ways without leaving the scope of the invention. For the sake of completeness, it is also pointed out that the use of the indefinite articles “a” or “one” does not exclude the possibility that the features in question may also be present more than once.

1. Battery-operated device (2; 2A-2G), in particular a display device, which comprises
a first communication stage (25) for wireless communication, in particular radio communication, with a data processing facility (6), and
a second communication stage (22) which is designed to wirelessly query with an initiator device (4; 4A-4B), which differs from the data processing facility (6), whether there is a need for communication between the device (2; 2A-2G) and the data processing facility (6) via the first communication stage (25), and
wherein the battery-operated device (2; 2A-2G) is designed to establish communication with the data processing facility (6) with the aid of the first communication stage (25) if the need exists.

2. Battery-operated device (2; 2A-2G) according to claim 1, wherein the second communication stage (22) is designed to instruct the first communication stage (25) for the purpose of establishing communication with the data processing facility if the need exists.

3. Battery-operated device (2; 2A-2G) according to claim 1, comprising an active mode and an energy-saving mode, wherein
in the active mode, at least the first communication stage (25) is ready for communication with the data processing facility (6), and wherein
in the energy-saving mode, at least the first communication stage (25) is deactivated, in particular with regard to its communication capability, in particular is switched off, and wherein
the device (2; 2A-2G) is designed to transfer at least the first communication stage (25) from the energy-saving mode to the active mode if the need exists.

4. Battery-operated device (2; 2A-2G) according to claim 3, wherein the second communication stage (22) is designed to initiate the transfer of at least the first communication stage (25) from the energy-saving mode to the active mode if the need exists.

5. Battery-operated device (2; 2A-2G) according to claim 3, wherein the first communication stage (25) is designed to enter the energy-saving mode after communication with the data processing facility (6) has ended.

6. Battery-operated device (2; 2A-2G) according to claim 1, which is designed, in the event of a failed query with the initiator device (4; 4A-4B), preferably in the event of several failed queries, particularly preferably in the event of several immediately consecutive failed queries, to establish communication with the data processing facility (6) with the aid of the first communication stage (25).

7. Battery-operated device (2; 2A-2G) according to claim 1, wherein the device (2; 2A-2G) is designed to output data that was generated before communication with the data processing facility (6) was established, in particular in the device (2; 2A-2G), to the data processing facility via the first communication stage (25).

8. Battery-operated device (2; 2A-2G) according to claim 3, wherein the device (2; 2A-2G) is designed to utilize the first communication stage (25) in its active mode to output data generated during its energy-saving mode.

9. Battery-operated device (2; 2A-2G) according to claim 1, wherein the second communication stage (22) is designed to make the query with the initiator device (4; 4A-4B) depending on a trigger signal.

10. Battery-operated device (2; 2A-2G) according to claim 9, wherein the device (2; 2A-2G) comprises a sensor (5A, 5B), in particular a motion sensor, which is provided for generating the trigger signal.

11. Battery-operated device (2; 2A-2G) according to claim 9, wherein the device (2; 2A-2G) is designed to generate the trigger signal depending on the time.

12. Initiator device (4; 4A-4B) which comprises
a third communication stage (42) for communicating, in particular for radio communication, with a data processing facility (6), wherein a necessity indicator, which indicates a need for communication between the data processing facility (6) and another, in particular battery-operated, device (2; 2A-2G) is receivable, and
a fourth communication stage (45), which is designed to wirelessly inform the other, in particular battery-operated, device (2), in particular the one querying with it, whether the need for communication between the other, in particular battery-operated, device (2; 2A-2G) and the data processing facility (6) exists.

13. Initiator device (4; 4A-4B) according to claim 12, which comprises a power supply or is connected to a power supply which is more powerful than the power supply of the other, in particular battery-operated, device (2; 2A-2G).

14. Initiator device (4; 4A-4B) according to claim 12, which is formed by a battery-operated device (2; 2A-2G), in particular a display device, which comprises:
a first communication stage (25) for wireless communication, in particular radio communication, with a data processing facility (6), and
a second communication stage (22) which is designed to wirelessly query with an initiator device (4; 4A-4B), which differs from the data processing facility (6), whether there is a need for communication between the device (2; 2A-2G) and the data processing facility (6) via the first communication stage (25),
wherein the battery-operated device (2; 2A-2G) is designed to establish communication with the data processing facility (6) with the aid of the first communication stage (25) if the need exists, and
wherein the third communication stage is formed by the first communication stage (25) and wherein the fourth communication stage is formed by the second communication stage (22).

15. Communication system (1) comprising at least one battery-operated device (2; 2A-2G) according to claim 1 and at least one initiator device (4; 4A-4B) which comprises
a third communication stage (42) for communicating, in particular for radio communication, with a data processing facility (6), wherein a necessity indicator, which indicates a need for communication between the data processing facility (6) and another, in particular battery-operated, device (2; 2A-2G) is receivable, and
a fourth communication stage (45), which is designed to wirelessly inform the other, in particular battery-operated, device (2), in particular the one querying with it, whether the need for communication between the other, in particular battery-operated, device (2; 2A-2G) and the data processing facility (6) exists.
